(19) United States
(12) Patent Application Publication
(10) Pub. No.: US 2026/0330217 A1
(43) Pub. Date: Oct. 22, 2026

(54) SYSTEM FOR MULTI-OBJECTIVE PARAMETER OPTIMIZATION WITH DEEP-FEATURE GAUSSIAN PROCESS AND METHOD THEREOF, AND NON-TRANSITORY COMPUTER READABLE STORAGE MEDIUM

(71) Applicants: NATIONAL CHENG KUNG UNIVERSITY, Tainan City (TW); University of Texas at El Paso, El Paso, TX (US); National Taipei University of Business, Taipei City (TW)

(72) Inventors: Chin-Yi LIN, Taipei City (TW); Fan-Tien CHENG, Tainan City (TW); Tsung-Han TSAI, Tainan City (TW); Tzu-Liang TSENG, El Paso, TX (US); Yu-Ming HSIEH, Tainan City (TW)

(21) Appl. No.: 19/183,745

(22) Filed: Apr. 18, 2025

(51) Int. Cl. G06N 3/08

(52) U.S. Cl. CPC G06N 3/08

(57) ABSTRACT

Achieving optimal parameter settings in manufacturing is challenging due to the need to simultaneously meet conflicting multi-objective requirements, such as precise target metrology control and yield. A novel yield framework is introduced to incorporate a Multi-Objective Optimization with Deep-Feature Gaussian Process (MOODFG) algorithm, specifically designed to address these complexities. The framework enables the effective optimization of high-dimensional and interdependent process parameters, overcoming limitations of traditional methods. The key innovation of the MOODFG algorithm lies in its integration of deep-feature extraction and Gaussian process regression, which allows dynamic refinement of feature representations and surrogate models through iterative learning. This approach ensures robust convergence to optimal parameter values while efficiently balancing multiple objectives. In addition, significant improvements in yield, parameter stability, and process adaptability are achieved, highlighting the framework's transformative potential for semiconductor manufacturing.

### BACKGROUND

### Technical Field

The present disclosure relates to a system for multi-objective parameter optimization and a method thereof and a non-transitory computer readable storage medium, particularly relates to a system for multi-objective parameter optimization with a deep-feature Gaussian process and a method thereof, and a non-transitory computer readable storage medium.

### Description of Related Art

Optimization problems in high-dimensional multi-objective environments pose unique challenges, while existing methods such as Deep Kernel Learning Bayesian Optimization (DKL-BO) and Multi-Objective Bayesian Optimization (MO-BO) exhibit limitations in effectively addressing these challenges. These conventional methods have limitations in scalability, incremental data adaptability, and direct convergence to specific objective values, and thus are not the optimal choice for certain real-world application scenarios.

Existing multi-objective optimization methods exhibit some evident limitations, such as inability to provide specific objective-oriented parameter recommendations, insufficient modeling of multi-objective interactive effects, curses of dimensionality in high-dimensional data, and lack of dynamic adaptation capabilities. Therefore, there currently lacks a system for multi-objective parameter optimization with a deep-feature Gaussian process and a method thereof, and a non-transitory computer readable storage medium, which incorporates objective-oriented optimal parameter recommendations, dynamic feature learning and model updating, cross-parameter nonlinear interaction modeling, and automatic generation of dynamic recommendations in the market. Consequently, relevant practitioners are actively seeking solutions.

### SUMMARY

According to one implementation of a structural aspect of the present disclosure, a system for multi-objective parameter optimization with a deep-feature Gaussian process is provided, which includes a memory and a processor. The memory stores a plurality of process data, a plurality of metrology/testing data, and a specified multi-objective requirement, wherein the process data are used or generated when a production machine processes a plurality of workpieces, the process data are one-to-one corresponding to the workpieces, and each of the process data includes a plurality of process parameters. The metrology/testing data include a plurality of metrology data of the workpieces. The specified multi-objective requirement includes a plurality of specified objective values corresponding to a plurality of objectives. The processor is electrically connected to the memory, the processor receives the process data, the metrology/testing data, and the specified multi-objective requirement and is configured to perform operations including: performing a data processing and feature selection operation, a deep-feature extraction and Gaussian process modeling operation, and an optimization and parameter recommendation operation. The data processing and feature selection operation including analyzing the process data and the metrology/testing data by using a classification algorithm to select a plurality of key parameters relevant to the objectives. The deep-feature extraction and Gaussian process modeling operation includes performing a deep-feature extraction operation and a Gaussian process modeling operation. The deep-feature extraction operation includes employing a deep learning model to perform deep-feature extraction on the key parameters, map the key parameters to a latent space, and generate a plurality of transformed feature vectors, wherein the key parameters have a higher dimensionality than the latent space. The Gaussian process modeling operation includes establishing a Gaussian process model for each of the objectives and inputting the transformed feature vectors into the Gaussian process model to generate an objective value. The optimization and parameter recommendation operation includes performing a multi-objective optimization based on the deep learning model, the Gaussian process model, and an iterative approach to search for an optimal parameter combination in which the objective values respectively corresponding to the objectives satisfy the specified multi-objective requirement.

According to one implementation of a method aspect of the present disclosure, a method for multi-objective parameter optimization with a deep-feature Gaussian process is provided, which includes: obtaining, by a processor, a plurality of process data, a plurality of metrology/testing data, and a specified multi-objective requirement, wherein the process data are used or generated when a production machine processes a plurality of workpieces, the process data are one-to-one corresponding to the workpieces, each of the process data includes a plurality of process parameters, the metrology/testing data includes a plurality of metrology data of the workpieces, and the specified multi-objective requirement includes a plurality of specified objective values corresponding to a plurality of objectives; performing, by the processor, a data processing and feature selection operation, the data processing and feature selection operation including analyzing the process data and the metrology/testing data by using a classification algorithm to select a plurality of key parameters relevant to the objectives; performing, by the processor, a deep-feature extraction and Gaussian process modeling operation, the deep-feature extraction and Gaussian process modeling operation including: performing a deep-feature extraction operation, the deep-feature extraction operation including employing a deep learning model to perform deep-feature extraction on the key parameters, map the key parameters to a latent space, and generate a plurality of transformed feature vectors, wherein the key parameters have a higher dimensionality than the latent space; and performing a Gaussian process modeling operation, the Gaussian process modeling operation including establishing a Gaussian process model for each of the objectives and inputting the transformed feature vectors into the Gaussian process model to generate an objective value; and performing, by the processor, an optimization and parameter recommendation operation, the optimization and parameter recommendation operation including performing a multi-objective optimization based on the deep learning model, the Gaussian process model, and an iterative approach to search for an optimal parameter combination in which the objective values respectively corresponding to the objectives satisfy the specified multi-objective requirement.

According to another implementation of the structural/method aspect of the present disclosure, a non-transitory computer readable storage medium is provided, which has a plurality of instructions. When the instructions are executed on a processor, the processor is caused to perform a method for multi-objective parameter optimization with a deep-feature Gaussian process. The method for multi-objective parameter optimization with the deep-feature Gaussian process includes: obtaining, by a processor, a plurality of process data, a plurality of metrology/testing data, and a specified multi-objective requirement, wherein the process data are used or generated when a production machine processes a plurality of workpieces, the process data are one-to-one corresponding to the workpieces, each of the process data includes a plurality of process parameters, the metrology/testing data include a plurality of metrology data of the workpieces, and the specified multi-objective requirement includes a plurality of specified objective values corresponding to a plurality of objectives; performing, by the processor, a data processing and feature selection operation, the data processing and feature selection operation including analyzing the process data and the metrology/testing data by using a classification algorithm to select a plurality of key parameters relevant to the objectives; performing, by the processor, a deep-feature extraction and Gaussian process modeling operation, the deep-feature extraction and Gaussian process modeling operation including: performing a deep-feature extraction operation, the deep-feature extraction operation including employing a deep learning model to perform deep-feature extraction on the key parameters, map the key parameters to a latent space, and generate a plurality of transformed feature vectors, wherein the key parameters have a higher dimensionality than the latent space; and performing a Gaussian process modeling operation, the Gaussian process modeling operation including establishing a Gaussian process model for each of the objectives and inputting the transformed feature vectors into the Gaussian process model to generate an objective value; and performing, by the processor, an optimization and parameter recommendation operation, the optimization and parameter recommendation operation including performing a multi-objective optimization based on the deep learning model, the Gaussian process model, and an iterative approach to search for an optimal parameter combination in which the objective values respectively corresponding to the objectives satisfy the specified multi-objective requirement.

### BRIEF DESCRIPTION OF THE DRAWINGS

For a more complete understanding of embodiments and advantages thereof, the description below is made with reference to the drawings, in which:

FIG. 1 is a block schematic diagram illustrating a system for multi-objective parameter optimization with a deep-feature Gaussian process according to a first embodiment of the present disclosure.

FIG. 2 is a schematic diagram illustrating multi-layer interconnection relationships of the system for multi-objective parameter optimization with a deep-feature Gaussian process of FIG. 1 applied in a manufacturing environment.

FIG. 3A is a flow schematic diagram illustrating a method for multi-objective parameter optimization with a deep-feature Gaussian process according to a second embodiment of the present disclosure.

FIG. 3B is a flow schematic diagram illustrating a method for multi-objective parameter optimization with a deep-feature Gaussian process according to a third embodiment of the present disclosure.

FIG. 4 is a schematic diagram illustrating multi-objective parameter optimization with a deep-feature Gaussian process according to an embodiment of the present disclosure.

FIG. 5A is a schematic diagram illustrating convergence of a first key parameter in an optimization process according to the present disclosure.

FIG. 5B is a schematic diagram illustrating convergence of a second key parameter in the optimization process according to the present disclosure.

FIG. 5C is a schematic diagram illustrating convergence of a third key parameter in the optimization process according to the present disclosure.

FIG. 5D is a schematic diagram illustrating convergence of a fourth key parameter in the optimization process according to the present disclosure.

FIG. 5E is a schematic diagram illustrating convergence of a fifth key parameter in the optimization process according to the present disclosure.

FIG. 5F is a schematic diagram illustrating convergence of a sixth key parameter in the optimization process according to the present disclosure.

FIG. 5G is a schematic diagram illustrating convergence of a seventh key parameter in the optimization process according to the present disclosure.

FIG. 5H is a schematic diagram illustrating convergence of an eighth key parameter in the optimization process according to the present disclosure.

FIG. 5I is a schematic diagram illustrating convergence of a ninth key parameter in the optimization process according to the present disclosure.

FIG. 5J is a schematic diagram illustrating convergence of a tenth key parameter in the optimization process according to the present disclosure.

FIG. 5K is a schematic diagram illustrating convergence of an eleventh key parameter in the optimization process according to the present disclosure.

FIG. 5L is a schematic diagram illustrating convergence of a twelfth key parameter in the optimization process according to the present disclosure.

FIG. 5M is a schematic diagram illustrating convergence of a thirteenth key parameter in the optimization process according to the present disclosure.

FIG. 5N is a schematic diagram illustrating convergence of a fourteenth key parameter in the optimization process according to the present disclosure.

FIG. 5O is a schematic diagram illustrating convergence of a fifteenth key parameter in the optimization process according to the present disclosure.

FIG. 6A is a schematic diagram illustrating convergence of a first objective (thickness) in the optimization process according to the present disclosure.

FIG. 6B is a schematic diagram illustrating convergence of a second objective (doping concentration) in the optimization process according to the present disclosure.

FIG. 7A is a schematic diagram illustrating a simulated prediction result for thickness of the method for multi-objective parameter optimization with a deep-feature Gaussian process applied in a semiconductor manufacture according to the present disclosure.

FIG. 7B is a schematic diagram illustrating a simulated prediction result for doping concentration of the method for multi-objective parameter optimization with a deep-feature Gaussian process applied in the semiconductor manufacture according to the present disclosure.

FIG. 8A is a schematic diagram illustrating a comparison of parameter values of the first key parameter before and after optimization according to the present disclosure.

FIG. 8B is a schematic diagram illustrating a comparison of parameter values of the second key parameter before and after optimization according to the present disclosure.

FIG. 8C is a schematic diagram illustrating a comparison of parameter values of the third key parameter before and after optimization according to the present disclosure.

FIG. 8D is a schematic diagram illustrating a comparison of parameter values of the fourth key parameter before and after optimization according to the present disclosure.

FIG. 8E is a schematic diagram illustrating a comparison of parameter values of the fifth key parameter before and after optimization according to the present disclosure.

FIG. 8F is a schematic diagram illustrating a comparison of parameter values of the sixth key parameter before and after optimization according to the present disclosure.

FIG. 8G is a schematic diagram illustrating a comparison of parameter values of the seventh key parameter before and after optimization according to the present disclosure.

FIG. 8H is a schematic diagram illustrating a comparison of parameter values of the eighth key parameter before and after optimization according to the present disclosure.

FIG. 8I is a schematic diagram illustrating a comparison of parameter values of the ninth key parameter before and after optimization according to the present disclosure.

FIG. 8J is a schematic diagram illustrating a comparison of parameter values of the tenth key parameter before and after optimization according to the present disclosure.

FIG. 8K is a schematic diagram illustrating a comparison of parameter values of the eleventh key parameter before and after optimization according to the present disclosure.

FIG. 8L is a schematic diagram illustrating a comparison of parameter values of the twelfth key parameter before and after optimization according to the present disclosure.

FIG. 8M is a schematic diagram illustrating a comparison of parameter values of the thirteenth key parameter before and after optimization according to the present disclosure.

FIG. 8N is a schematic diagram illustrating a comparison of parameter values of the fourteenth key parameter before and after optimization according to the present disclosure.

FIG. 8O is a schematic diagram illustrating a comparison of parameter values of the fifteenth key parameter before and after optimization according to the present disclosure.

FIG. 9 is a block schematic diagram illustrating a system for multi-objective parameter optimization with a deep-feature Gaussian process according to a fourth embodiment of the present disclosure.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

It will be understood that when an element (or device) is referred to as be “connected to” another element, it can be directly connected to the other element, or it can be indirectly connected to the other element, that is, intervening elements may be present. In contrast, when an element is referred to as be “directly connected to” another element, there are no intervening elements present. In addition, the terms first, second, third, etc., are used herein to describe various elements or components, these elements or components should not be limited by these terms. Consequently, a first element or component discussed below could be termed a second element or component.

Achieving optimal parameter settings in manufacturing is challenging due to the need to simultaneously meet conflicting multi-objective requirements, such as precise target metrology control and yield. The present disclosure introduces a novel yield framework that incorporates a Multi-Objective Optimization with Deep-Feature Gaussian Process (MOODFG) algorithm, specifically designed to address these complexities. The framework enables the effective optimization of high-dimensional and interdependent process parameters, overcoming limitations of traditional methods. The key innovation of the MOODFG algorithm lies in its integration of deep-feature extraction and Gaussian process regression, which allows dynamic refinement of feature representations and surrogate models through iterative learning. The approach ensures robust convergence of parameter values while efficiently balancing multiple objectives. Based on experimental validation using real-world Epi SiC manufacturing data, the framework has achieved significant improvements in yield, parameter stability, and process adaptability, highlighting the framework's transformative potential for semiconductor manufacturing.

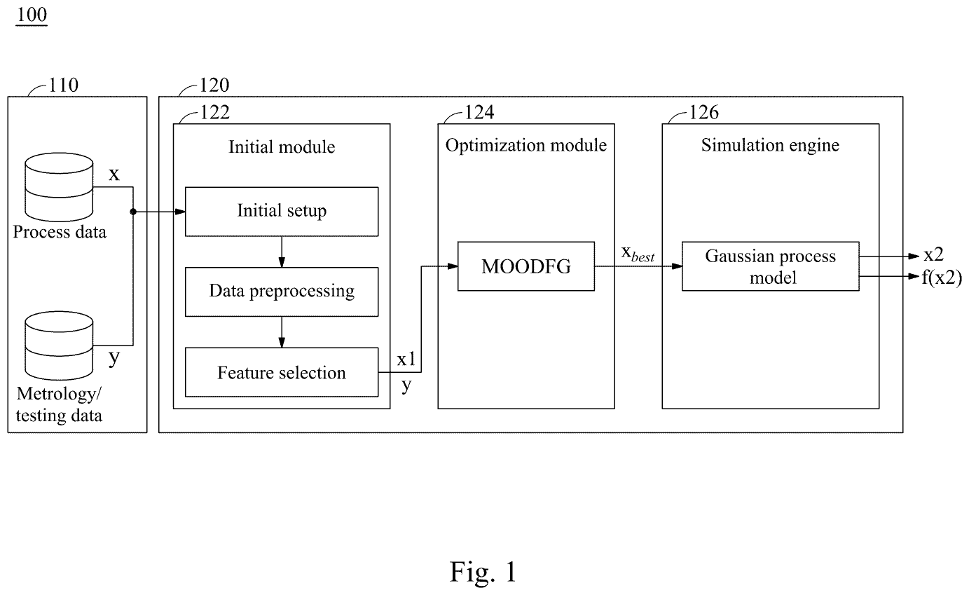

Reference is made to FIG. 1 which is a block schematic diagram illustrating a system 100 for multi-objective parameter optimization with a deep-feature Gaussian process according to a first embodiment of the present disclosure. The system 100 for multi-objective parameter optimization with the deep-feature Gaussian process includes a memory 110 and a processor 120. The memory 110 stores a plurality of process data x, a plurality of metrology/testing data y, and a specified multi-objective requirement, where the process data x are used or generated when a production machine processes a plurality of workpieces, the process data x are one-to-one corresponding to the workpieces, each of the process data x includes a plurality of process parameters. The metrology/testing data y include a plurality of metrology data of the workpieces, and the specified multi-objective requirement includes a plurality of specified objective values corresponding to a plurality of objectives. The processor 120 is electrically connected to the memory 110, and the processor 120 receives the process data x, the metrology/testing data y, and the specified multi-objective requirement, and is configured to perform operations including: performing a data processing and feature selection operation, a deep-feature extraction and Gaussian process modeling operation, and an optimization and parameter recommendation operation. The processor 120 includes an initial module 122, an optimization module 124 and a simulation engine 126. Any one of the initial module 122, the optimization module 124, and the simulation engine 126 is a software module. The initial module 122, the optimization module 124, and the simulation engine 126 respectively perform the data processing and feature selection operation, the deep-feature extraction and Gaussian process modeling operation, and the optimization and parameter recommendation operation. The initial module 122 includes initial setup, data preprocessing, and feature selection.

The data processing and feature selection operation includes analyzing the process data x and the metrology/testing data y by using a classification algorithm to select a plurality of key parameters x1 relevant to the objectives. The deep-feature extraction and Gaussian process modeling operation includes performing a deep-feature extraction operation and a Gaussian process modeling operation. The deep-feature extraction operation includes employing a deep learning model to perform deep-feature extraction on the key parameters x1, map the key parameters to a latent space, and generate a plurality of transformed feature vectors, where the key parameters x1 have a higher dimensionality than the latent space. The Gaussian process modeling operation includes establishing a Gaussian process model for each of the objectives and inputting the transformed feature vectors into the Gaussian process model to generate an objective value. The optimization and parameter recommendation operation includes performing a multi-objective optimization based on the deep learning model, the Gaussian process model, and an iterative approach to search for an optimal parameter combination x2 in which the objective values corresponding to each of the objectives satisfy the specified multi-objective requirement.

The memory 110 may include a cloud memory, a random access memory (RAM) that may store information and instructions executable by a cloud processor, or other types of dynamic storage devices. The information and instructions include the process data x, the metrology/testing data y, and the specified multi-objective requirement. The processor 120 may include any type of processor, microprocessor, cloud processor, or field programmable gate array (FPGA) capable of compiling and executing instructions. The processor 120 may include a single device (e.g., single-core) or a group of devices (e.g., multi-core), but the present disclosure is not limited thereto.

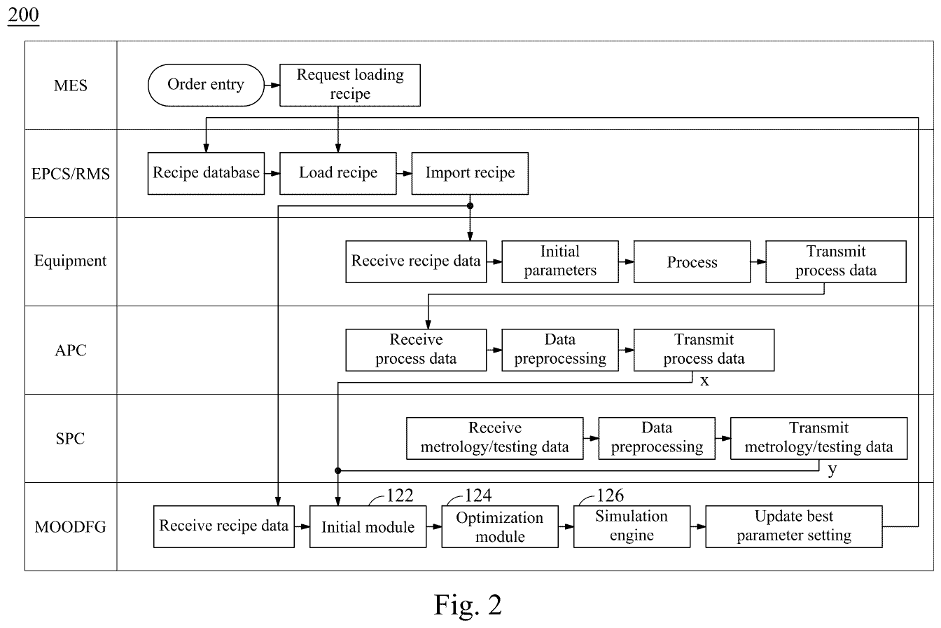

Reference is made to FIGS. 1 and 2, in which FIG. 2 is a schematic diagram illustrating multi-layer interconnection relationships of the system 100 for multi-objective parameter optimization with the deep-feature Gaussian process of FIG. 1 applied in a manufacturing environment. FIG. 2 may be regarded as a workflow 200 of MOODFG and a semiconductor manufacturing system. The workflow 200 includes a manufacturing execution system (MES) layer, an equipment parameter configuration system/recipe management system (EPCS/RMS) layer, an equipment layer, an advanced process control (APC) layer, a statistical process control (SPC) layer, and a multi-objective optimization with deep-feature Gaussian process (MOODFG) layer. The MES layer includes order entry and request loading recipe. The EPCS/RMS layer includes a recipe database, load recipe, and import recipe. The equipment layer includes receive recipe data, initial parameters, process, and transmit process data. The APC layer includes receive process data, data preprocessing, and transmit process data x. The SPC layer includes receive metrology/testing data, data preprocessing, and transmit metrology/testing data y. The MOODFG layer includes receive recipe data, the initial module 122, the optimization module 124, the simulation engine 126, and update best parameter setting. The metrology/testing data y may further include testing data for testing the workpieces. The above layers help ensure seamless data flow and optimization throughout the manufacturing lifecycle. Thus, the present disclosure utilizes the synergy between the MES layer, the EPCS/RMS layer, the equipment layer, the APC layer, and the SPC layer, and integrates the above layers with the MOODFG layer, which can significantly enhance the visibility, predictive analytics, and parameter optimization of the workflow. The workflow 200 not only maximizes the efficiency and output of the process but also lays a solid foundation for the development of future adaptive and autonomous manufacturing systems, thereby promoting the continuous development of the semiconductor manufacturing landscape.

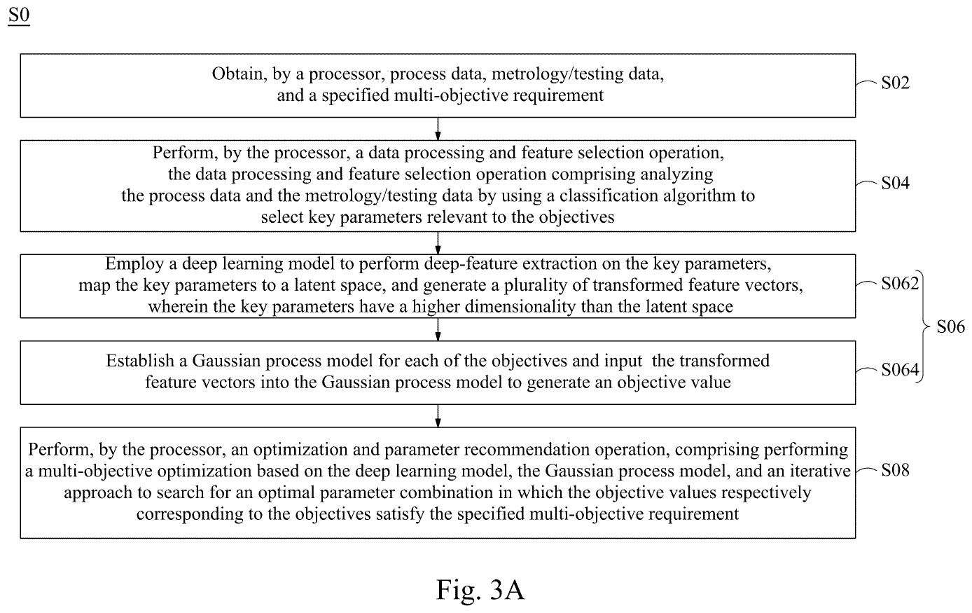

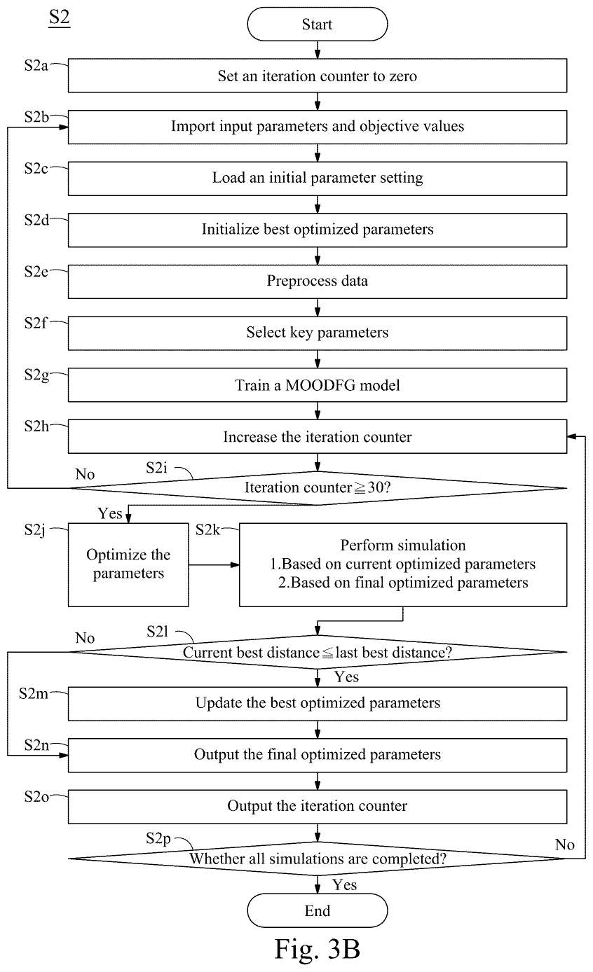

Reference is made to FIGS. 1, 2, and 3A, in which FIG. 3A is a flow schematic diagram illustrating a method S0 for multi-objective parameter optimization with a deep-feature Gaussian process according to a second embodiment of the present disclosure. The method S0 for multi-objective parameter optimization with the deep-feature Gaussian process is applied to the system 100 for multi-objective parameter optimization with the deep-feature Gaussian process and includes a plurality of steps S02, S04, S06 and S08.

Step S02 includes obtaining, by a processor 120, a plurality of process data x, a plurality of metrology/testing data y, and a specified multi-objective requirement, where the process data x are used or generated when a production machine processes a plurality of workpieces, the process data x are one-to-one corresponding to the workpieces, each of the process data x includes a plurality of process parameters, the metrology/testing data y include a plurality of metrology data of the workpieces, and the specified multi-objective requirement includes a plurality of specified objective values corresponding to a plurality of objectives.

Step S04 includes performing, by the processor 120, a data processing and feature selection operation, the data processing and feature selection operation including analyzing the process data x and the metrology/testing data y by using a classification algorithm to select a plurality of key parameters x1 relevant to the objectives.

Step S06 includes performing, by the processor 120, a deep-feature extraction and Gaussian process modeling operation, the deep-feature extraction and Gaussian process modeling operation including performing a deep-feature extraction operation S062 and a Gaussian process modeling operation S064. The deep-feature extraction operation S062 includes employing a deep learning model to perform deep-feature extraction on the key parameters x1, map the key parameters to a latent space, and generate a plurality of transformed feature vectors, where the key parameters x1 have a higher dimensionality than the latent space. The Gaussian process modeling operation S064 includes establishing a Gaussian process model for each of the objectives and inputting the transformed feature vectors into the Gaussian process model to generate an objective value.

Step S08 includes performing, by the processor 120, an optimization and parameter recommendation operation, the optimization and parameter recommendation operation including performing a multi-objective optimization based on the deep learning model, the Gaussian process model, and an iterative approach to search for an optimal parameter combination x2 in which the objective values respectively corresponding to each of the objectives satisfy the specified multi-objective requirement.

Reference is made to FIGS. 1, 2, 3A, and 3B, in which FIG. 3B is a flow schematic diagram illustrating a method S2 for multi-objective parameter optimization with a deep-feature Gaussian process according to a third embodiment of the present disclosure. The method S2 for multi-objective parameter optimization with the deep-feature Gaussian process is applied to the system 100 for multi-objective parameter optimization with the deep-feature Gaussian process and includes a plurality of steps S2a, S2b, S2c, S2d, S2e, S2f, S2g, S2h, S2i, S2j, S2k, S2l, S2m, S2n, S2o, and S2p.

Step S2a includes setting an iteration counter to zero (Iteration counter=0). Step S2b includes importing a plurality of input parameters (e.g., temperature, pressure, gas flow rate, etc.) and a plurality of objective values (e.g., yield, thickness uniformity, doping concentration, etc.). The input parameters may be process data x, the objective values may be metrology/testing data y. Step S2c includes loading an initial parameter setting. Step S2d includes initializing best optimized parameters. Step S2e includes preprocessing data. Step S2f includes selecting key parameters x1. Steps S2a, S2b, S2c, S2d, S2e, and S2f correspond to the initial module 122 in FIG. 1.

Step S2g includes training a MOODFG model. Step S2h includes increasing the iteration counter (+1). Step S2i includes confirming whether the iteration counter is greater than or equal to 30; if yes, proceeding to Step S2j; if no, re-performing Step S2b. Step S2j includes optimizing the parameters. Steps S2g, S2h, S2i, and S2j correspond to the optimization module 124 in FIG. 1.

Step S2k includes performing simulation, which is based on current optimized parameters or final optimized parameters. Step S2l includes confirming whether a current optimal distance is less than or equal to a final optimal distance; if yes, proceeding to Step S2m; if no, proceeding to Step S2n. Step S2m includes updating the best optimized parameters. Step S2n includes outputting the final optimized parameters. Step S2o includes outputting the iteration counter. Step S2p includes confirming whether all simulations are completed; if yes, ending (completing the method S2 for multi-objective parameter optimization with the deep-feature Gaussian process); if no, re-performing Step S2h. Steps S2k, S2l, S2m, S2n, S2o, and S2p correspond to the simulation engine 126 in FIG. 1.

Specifically, the classification algorithm is analyzed as an extreme Gradient Boosting (XGboost) algorithm, which conforms to Equation (1) and Table I:

x1=arg max_{x⊆{x}_{₁}_{,x}_{₂}_{, . . . ,x}_{_{d}}_{}}Σₓ_{ⱼ}_{∈x}Iⱼ subject to Σₓ_{ⱼ}_{∈x}Iⱼ≥γ (1).

TABLE I

| Symbol | Definition |
|---|---|
| x | Process parameters |
| d | Number of input parameters |
| D | Training dataset {(Xn, yn )}_{n = 1}^{N} |
| N | Number of samples in the dataset |
| yₙ | Metrology objective value (∈ R^{M}) |
| Mⱼ | Number of objectives |
| Iⱼ | Feature importance score of a j-th parameter |
| x1 | Key parameter |
| γ | Importance threshold |

In one embodiment, the deep learning model may be a two-layer neural network, and the two-layer neural network includes two Rectified Linear Unit (ReLU) functions which conform to Equation (2) and Table II:

z=h_{θ}(x)=ReLU(W₂·ReLU(W₁x+b₁)+b₂) (2).

TABLE II

| Symbol | Definition |
|---|---|
| f(x) | Vector of the objective functions |
| | ([f₁(x), f₂(x), ... , f_{M}(x)]^{T}) |
| M | Number of objectives |
| h_{θ} | Deep-feature extractor function |
| z | Transformed feature vector (ϵE R^{k}) |
| k | Dimensionality of the latent space (k << d) |
| W₁, W₂ | Weights of the neural network layer |
| b₁, b₂ | Biases of the neural network layer |
| GP | Gaussian process |
| μ_{y}_{₀} (z) | Mean function of the Gaussian process for an o-th |
| | objective |
| k_{y}_{₀} (z, z') | Kernel function of the Gaussian process for the o-th |
| | objective |
| L_{y}_{₀} | Marginal log-likelihood of an o-th Gaussian process |
| | model |
| θ_{y}_{₀} | Hyperparameter of the o-th Gaussian process model |

Reference is made to Equations (3), (4), (5) and Table II, in which Equation (3) defines the Gaussian process model for the o-th objective. Equations (4) and (5) are for calculating and optimizing a marginal log-likelihood (MLL) of the Gaussian process model to obtain a hyperparameter

$${θ}_{{y}_{o}}^{*}$$

of the Gaussian process model. Equations (2)-(5) primarily describe how the optimization module 124 performs model training and parameter optimization.

$${f}_{{y}_{o}} ( z ) ∼ 𝒢𝒫 ( {μ}_{{y}_{o}} ( z ) , {k}_{{y}_{o}} ( z , {z}^{′} ) ) ; \qquad ( 3 )$$

$$\begin{matrix}{L}_{{y}_{o}} = log p ( {y}_{{y}_{o}} \vert x 1 ) = - \frac{1}{2} {y}_{{y}_{o}}^{T} {K}_{{y}_{o}}^{- 1} {y}_{{y}_{o}} - \frac{1}{2} log \vert {K}_{{y}_{o}} \vert - \frac{n}{2} log 2 π ; & ( 4 )\end{matrix}$$

$${θ}_{{y}_{o}}^{*} = arg {min}_{{θ}_{{y}_{o}}} ( - {L}_{{y}_{o}} ) . \qquad ( 5 )$$

Reference is made to Equations (6), (7), (8), (9), and Table III, in which Equation (6) defines the deep learning model based on the key parameters x1. Equation (7) defines the Gaussian process model for the o-th objective based on the key parameters x1. Equation (8) integrates a multi-objective loss (or error) function. Equation (9) searches the entire candidate pool Xₚₒₒₗ for x_{best} that minimizes ƒ(x1) based on Equation (8). Equations (6)-(9) primarily describe how the simulation engine 126 computes a multi-objective distance function ƒ(x1) to find an optimal solution x_{best} and performs simulations to evaluate whether updates are required.

$$z = {h}_{θ} ( x 1 ) = ReLU ( {W}_{2} \cdot ReLU ( {W}_{1} x 1 + {b}_{1} ) + {b}_{2} ) ; \qquad ( 6 )$$

$${f}_{{y}_{o}} ( z ) ∼ 𝒢𝒫 ( {μ}_{{y}_{o}} ( z ) , {k}_{{y}_{o}} ( z , {z}^{′} ) ) ; \qquad ( 7 )$$

$$\begin{matrix}f ( x 1 ) = {\sum }_{0 = 1}^{M} {w}_{o} \vert {\hat{y}}_{o} ( x 1 ) - {y}_{o , target} \vert ; and & ( 8 )\end{matrix}$$

$${x}_{best} = arg {min}_{x 1 ∈ {X}_{pool}} f ( x 1 ) . \qquad ( 9 )$$

TABLE III

| Symbol | Definition |
|---|---|
| Y | Objective value vector [y₁, y₂, ... , y_{M}] |
| Xₜᵣₐᵢₙ | Training input data |
| Yₜᵣₐᵢₙ | Training objective data |
| Xₚₒₒₗ | Pool of candidate parameters for optimization |
| ŷₒ (x*) | Predicted mean value of the o-th objective |
| yₒ | Objective value of the o-th objective |
| Wₒ | Weight assigned to the o-th objective |
| f(x1) | Composite objective function value for x1 |
| x_{best} | Selected parameter set with minimal f (x1) |
| ×2 | Optimal parameter combination |

In step S04 (i.e., the data processing and feature selection operation), the number of the key parameters x1 is less than that of the process parameters of the process data x. In the deep-feature extraction operation S062 of step S06, the dimensionality of the key parameters x1 is higher than that of the transformed feature vectors. In the Gaussian process modeling operation S064 of step S06, the Gaussian process models is configured to surrogate an objective function corresponding to each of the objectives, and the transformed feature vectors are input into the Gaussian process model to generate the objective value and an uncertainty estimation.

In step S08, the iterative approach includes an iteration counter. The iteration counter can be greater than or equal to 10 and less than or equal to 60, with a preferred value of 30, but the present disclosure is not limited thereto. Furthermore, the multi-objective optimization includes simultaneously optimizing the objectives corresponding to a semiconductor manufacture. The semiconductor manufacture includes an epitaxial silicon carbide (Epi SiC) process, and the objectives include a thickness uniformity and a doping concentration. Additionally, the optimization and parameter recommendation operation further includes steps S082 and S084. Step S082 includes searching for a current optimal parameter combination based on a plurality of uncertainty estimations corresponding to the Gaussian process models of the objectives, to minimize deviations between the objective values generated by the Gaussian process models and the specified multi-objective requirement, where the current optimal parameter combination corresponds to the process parameters at a current time. Step S084 includes updating the deep learning model and the Gaussian process models using the iterative approach until the objective values generated by the updated Gaussian process models converge to the specified objective values of the specified multi-objective requirement. The multi-objective optimization corresponds to the objectives, and the optimal parameter combination x2 corresponds to the process parameters satisfying the specified multi-objective requirement.

The data processing and feature selection operation of Step S04, the deep-feature extraction and Gaussian process modeling operation of Step S06, and the optimization and parameter recommendation operation of Step S08 are sequentially performed, and the deep-feature extraction operation of Step S062 is performed prior to the Gaussian process modeling operation S064.

Thus, the system 100 for multi-objective parameter optimization with the deep-feature Gaussian process and the methods S0 and S2 for multi-objective parameter optimization with the deep-feature Gaussian process according to the present disclosure utilize the XGBoost algorithm to analyze the process data, which can reduce a high-dimensional parameter space into an influential parameter set, thereby lowering the computational complexity, and enhancing the subsequent modeling efficiency. Additionally, in the present disclosure, the deep learning model is employed, so that high-dimensional input parameters can be embedded into a low-dimensional latent space, which effectively captures nonlinear interactions between the parameters. The Gaussian process model is configured to surrogate objective functions and dynamically updated through incremental learning, and thus can adapt to real-time data changes. Furthermore, in the present disclosure, the MOODFG algorithm is used to perform multi-objective optimization, which can generate the optimal parameter combination x2 through a convergence strategy, thereby satisfying the user-specified multi-objective requirement (e.g., simultaneously achieving yield improvement and thickness uniformity improvement). The present disclosure adopts a continuously iterative learning method to guide search paths based on Gaussian process uncertainties, which can balance exploration and exploitation.

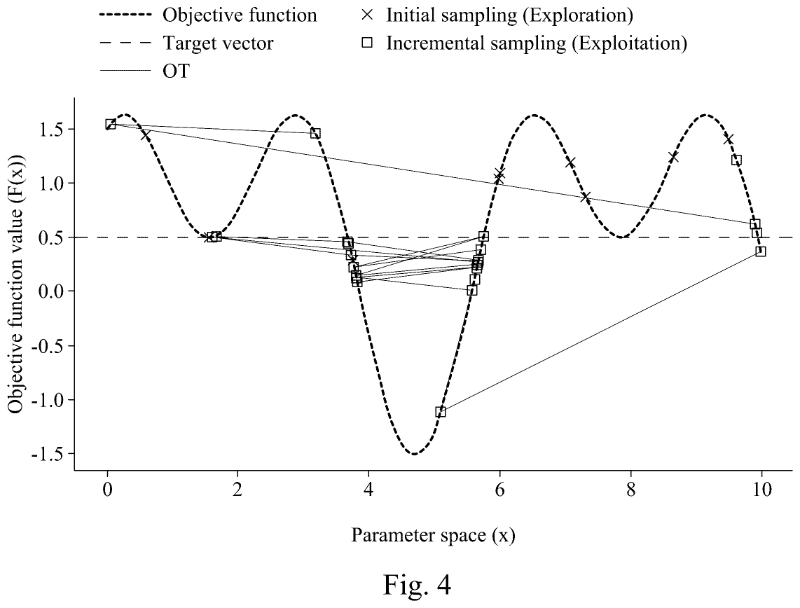

Reference is made to FIGS. 1, 2, 3A, 3B, and 4, in which FIG. 4 is a schematic diagram illustrating multi-objective parameter optimization with a deep-feature Gaussian process according to an embodiment of the present disclosure. In FIG. 4, a trajectory of the MOODFG algorithm is presented in a multi-objective parameter defined by the objective function F(x)=sin(x)+0.5+cos 2x, which provides a benchmark for evaluating an optimization trajectory OT. A target vector y*=[0,0.5] represents a desired optimization result. Initial sampling points represent an initial exploration phase, where the algorithm performs extensive sampling in the parameter space to learn a global structure of the objective function. A trajectory connecting the initial sampling points exhibits an initial random sampling pattern. Additionally, incremental sampling points represent incremental samples obtained during the exploitation phase. Since the MOODFG algorithm can optimize the search, the incremental sampling points are concentrated in a region near the target vector. Connection of the incremental sampling points can form the optimization trajectory OT which shows how the MOODFG algorithm transitions smoothly from exploration to exploitation, and gradually narrows the search scope to an objective region.

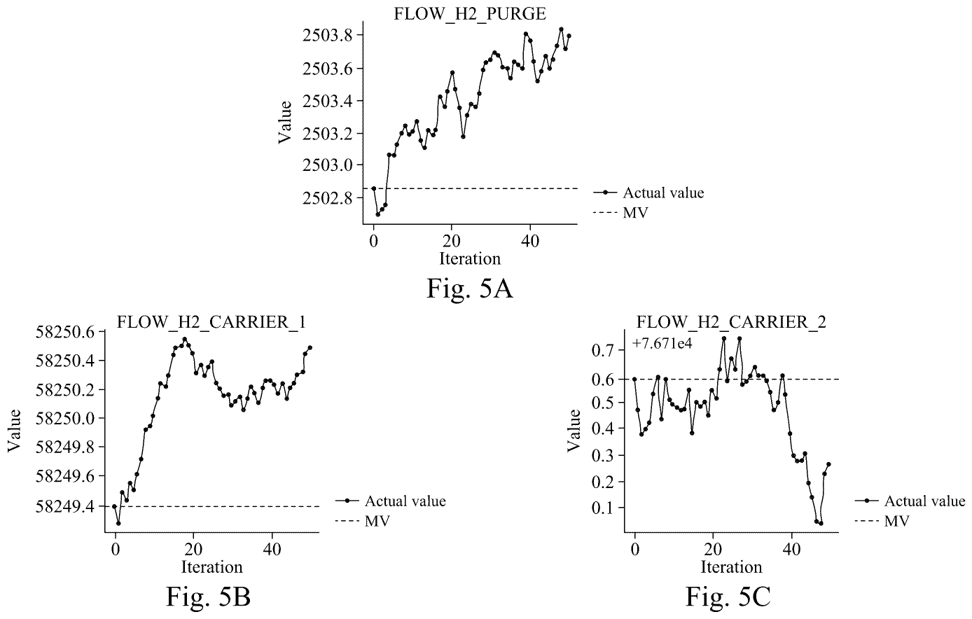

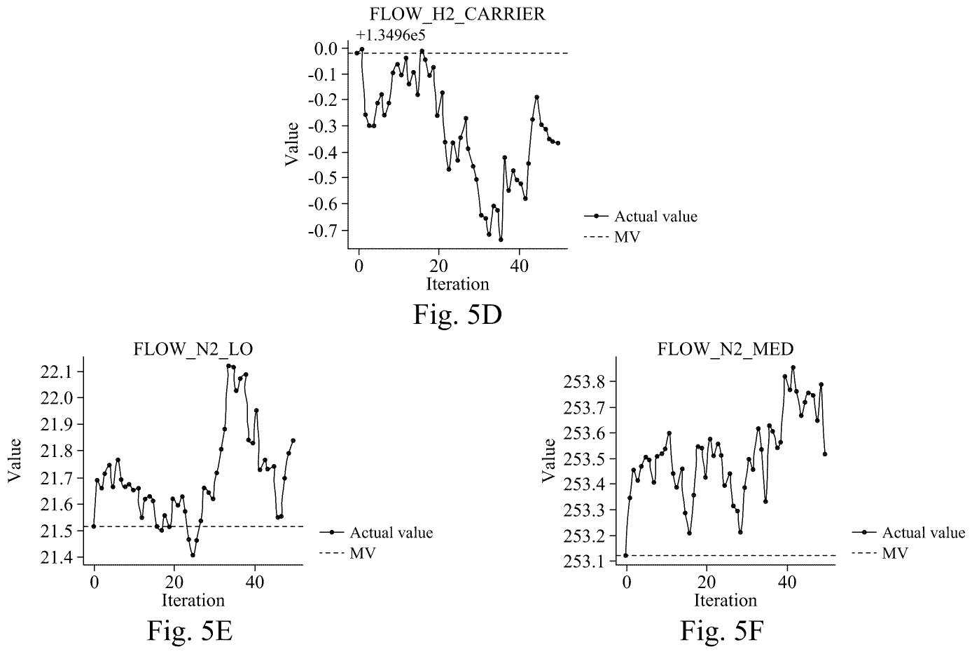

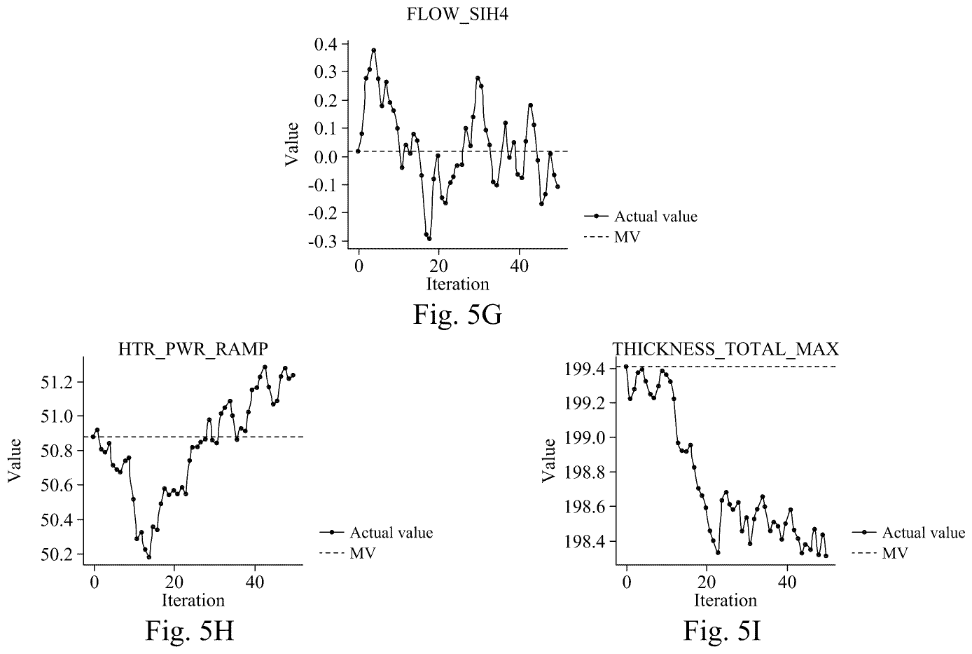

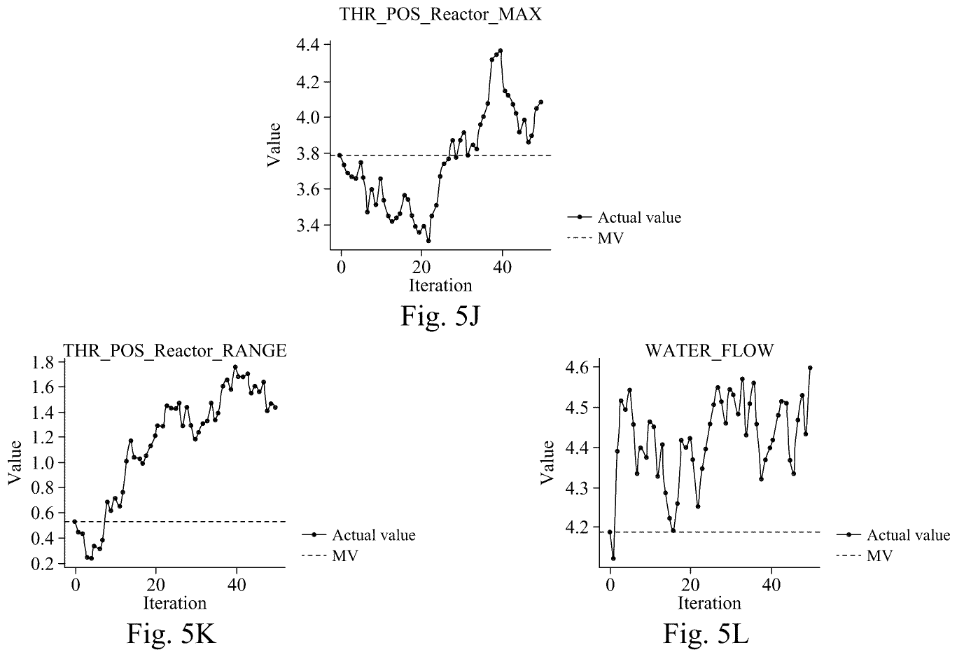

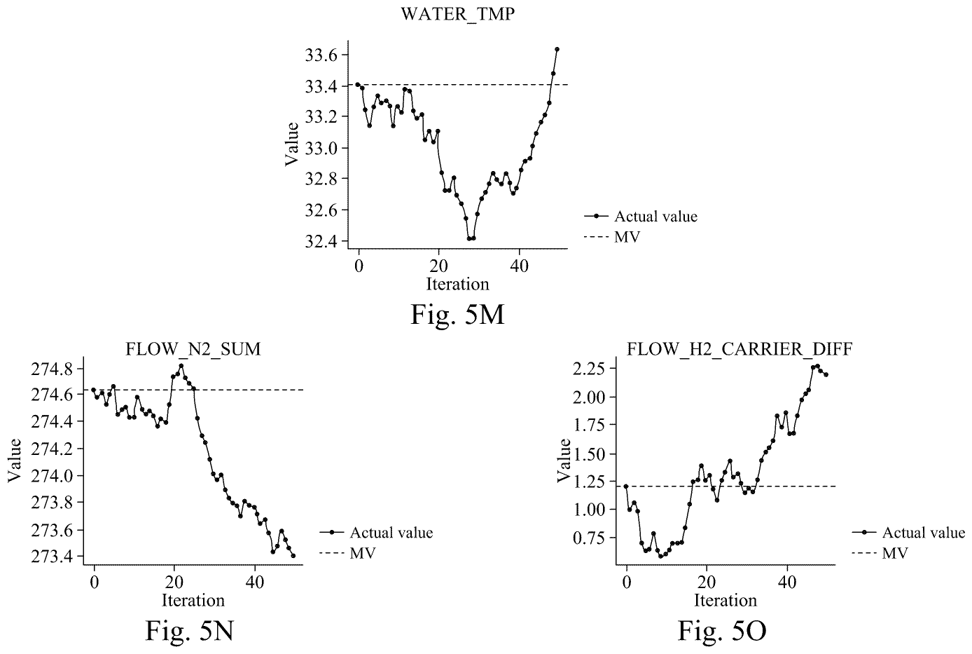

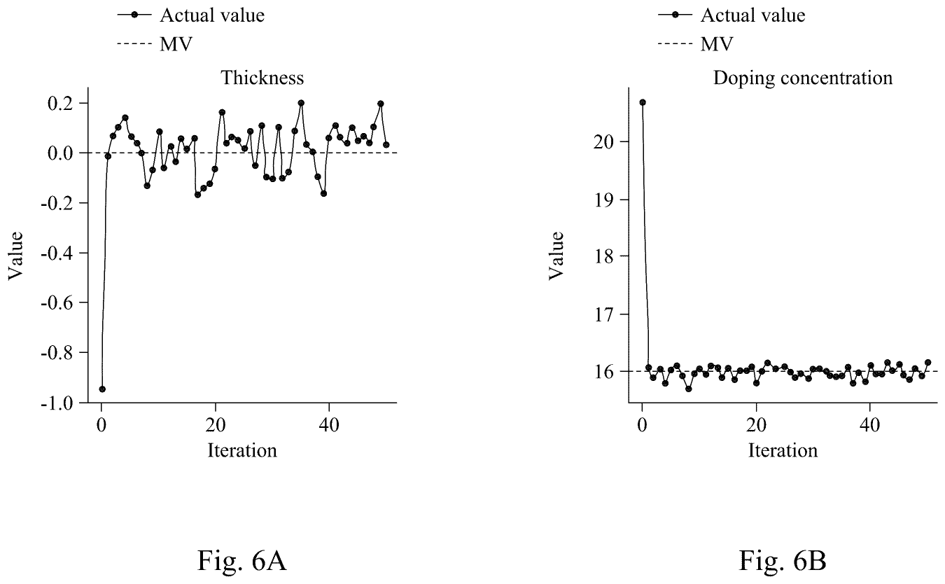

Reference is made to FIGS. 1, 2, 3A, 3B, 5A, 5B, 5O, 5D, 5E, 5F, 5G, 5H, 5I, 5J, 5K, 5L, 5M, 5N, 5O (FIGS. 5A to 5O), 6A, and 6B, in which FIGS. 5A to 5O are schematic diagrams respectively illustrating convergence of first to fifteenth key parameters in an optimization process according to the present disclosure, FIG. 6A is a schematic diagram illustrating convergence of a first objective (thickness) in the optimization process according to the present disclosure; and FIG. 6B is a schematic diagram illustrating convergence of a second objective (doping concentration) in the optimization process according to the present disclosure. Dashed lines represent mean values (MV). As can be seen from the figures, in the optimization process, as the objective output thickness and the doping concentration approach expected objectives, selected 15 key parameters x1 (i.e., the first to fifteenth key parameters in FIGS. 5A to 5O) converge to their respective optimal value ranges. Thereby, the iterative optimization process of the present disclosure can highlight that the MOODFG algorithm still has the capability to effectively adjust the parameters while considering complex interdependencies. In other words, the method according to the present disclosure ensures robust convergence to the parameter values while efficiently balancing multiple objectives.

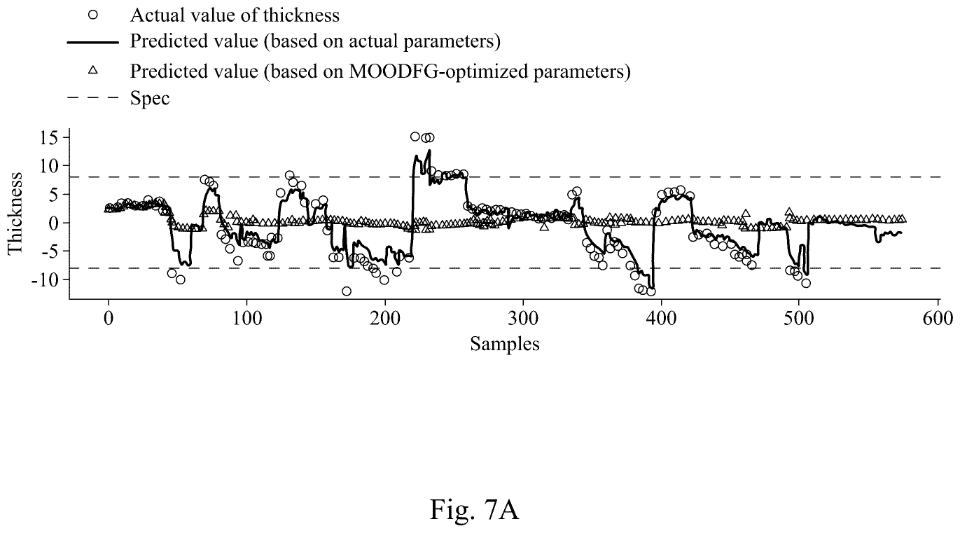

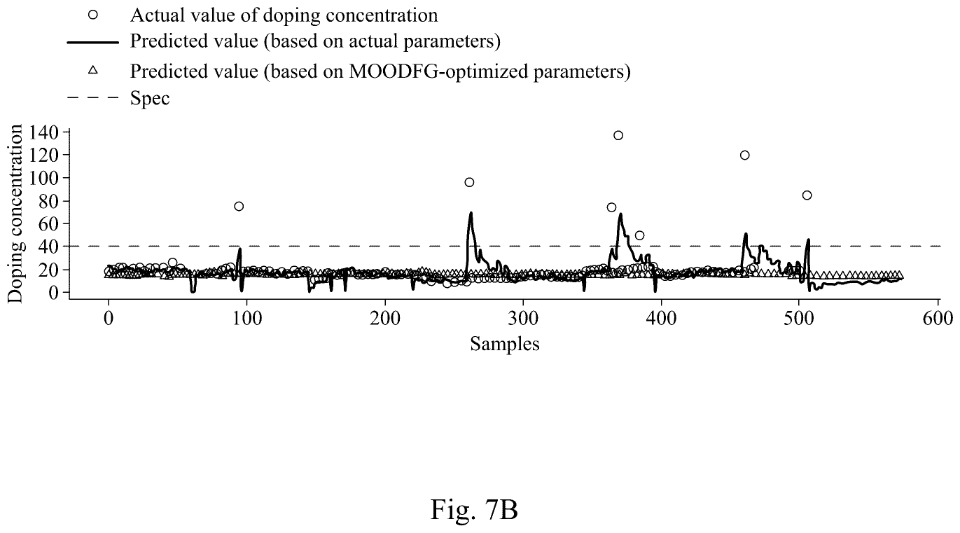

Reference is made to FIGS. 1, 2, 3A, 3B, 7A, and 7B, in which FIG. 7A is a schematic diagram illustrating a simulated prediction result for thickness of the methods S0 and S2 for multi-objective parameter optimization with the deep-feature Gaussian process applied in a semiconductor manufacture according to the present disclosure; and FIG. 7B is a schematic diagram illustrating a simulated prediction result for doping concentration of the methods S0 and S2 for multi-objective parameter optimization with the deep-feature Gaussian process applied in the semiconductor manufacture according to the present disclosure. Dashed lines represent standard specifications (Spec). As can be seen from the figures, both the thickness and the doping concentration achieve their desired objective values (the specified objective values for the thickness and the doping concentration are 0 and 16, respectively). Initially, a simulated predicted value of the thickness (based on MOODFG-optimized parameters) exceeds an objective value. However, as new samples are continuously incorporated into a MOODFG framework, the simulated predicted value of the thickness gradually converges to a specified objective value (0), as shown in FIG. 7A. A simulated predicted value of the doping concentration (based on the MOODFG-optimized parameters) is always close to a specified objective value (16), as shown in FIG. 7B. The aforementioned convergence demonstrates that the MOODFG algorithm of the present disclosure can dynamically optimize parameter prediction through iterative updates, thereby ensuring robust convergence. Furthermore, by comparing the predicted value based on the MOODFG-optimized parameters with the predicted value based on the actual parameters, it can be seen that a result exhibit high consistency with an actual value, thereby verifying that the MOODFG algorithm of the present disclosure has certain reliability and accuracy in estimating optimal parameter configurations.

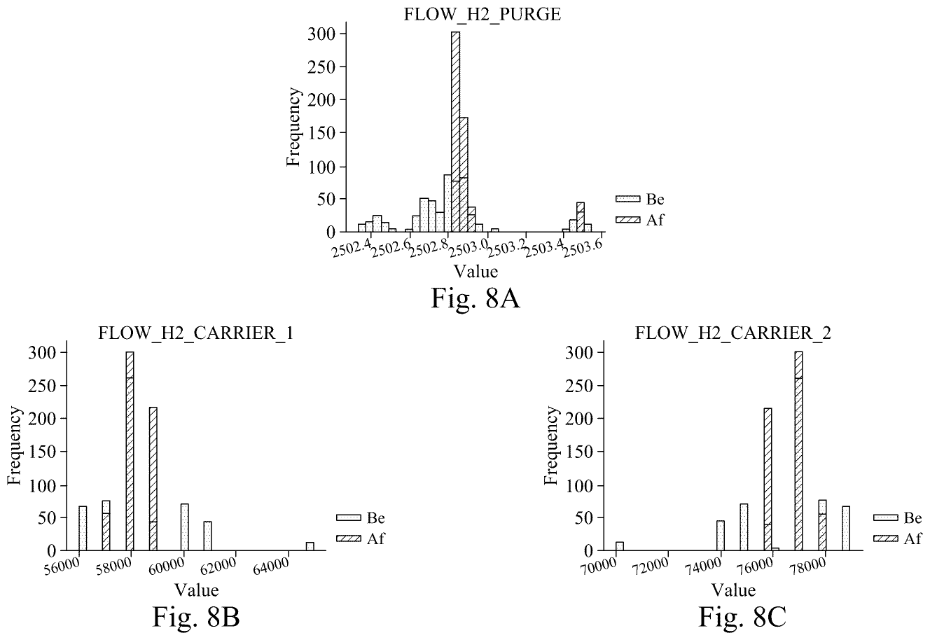

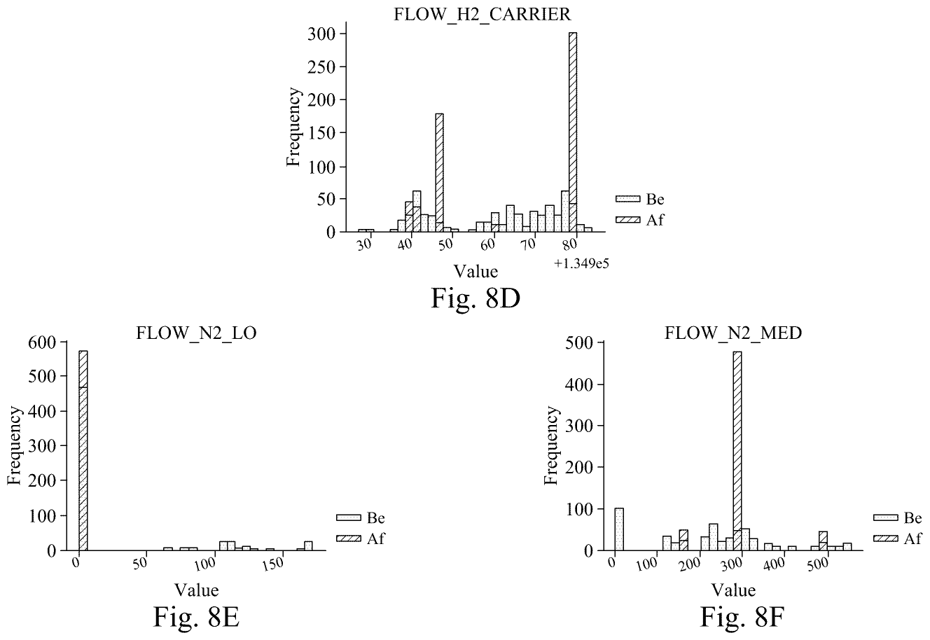

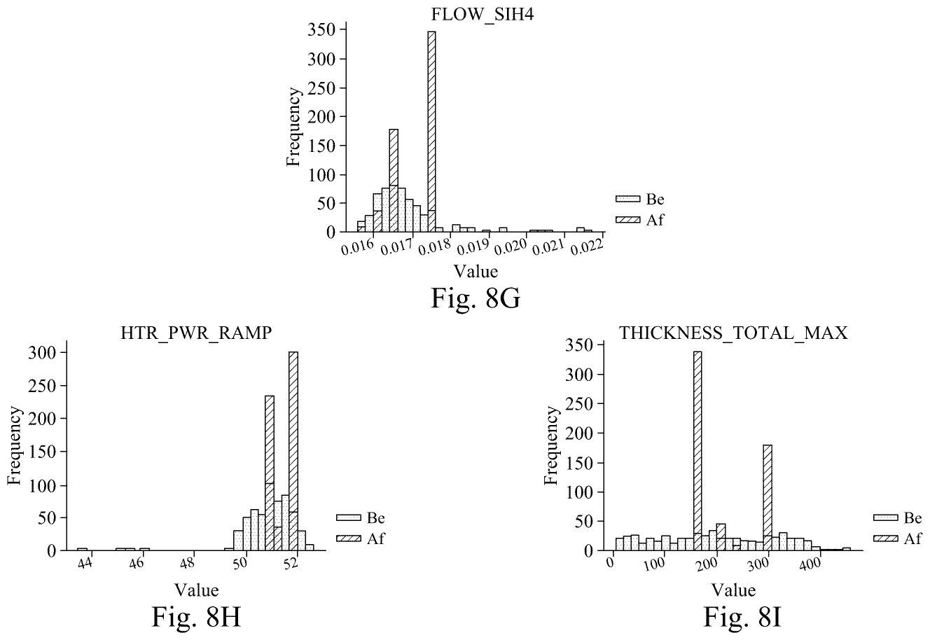

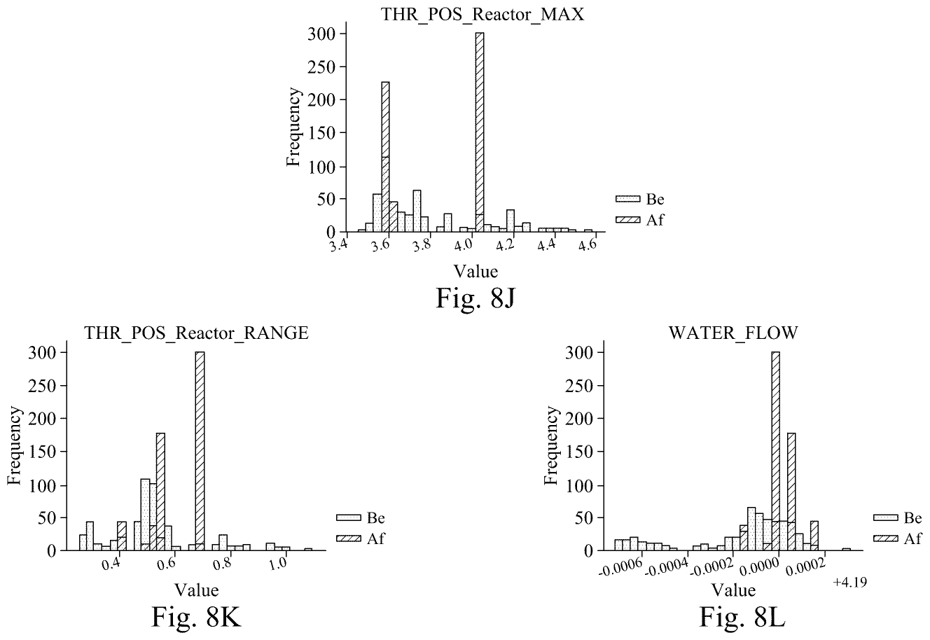

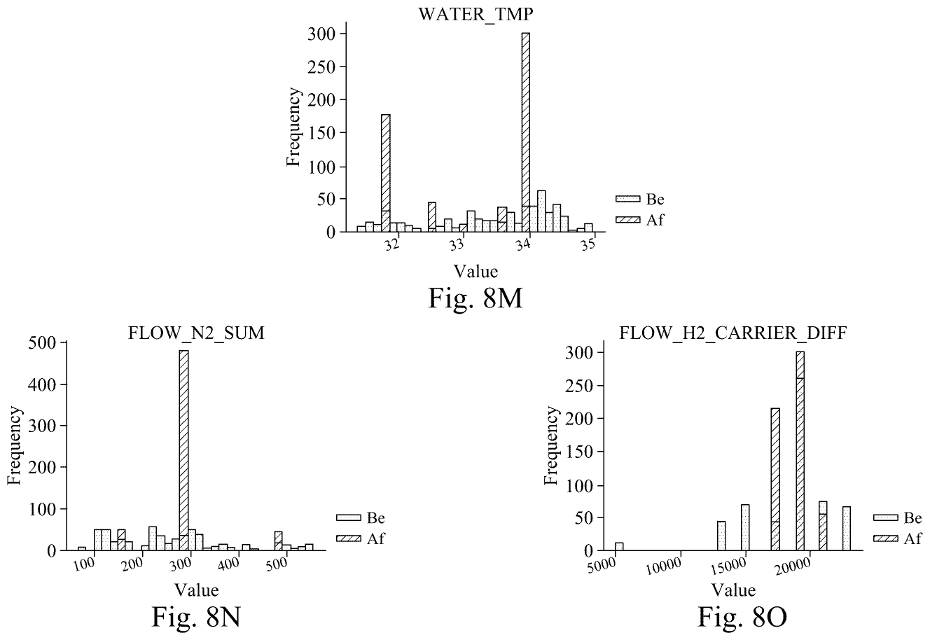

Reference is made to FIGS. 1, 2, 3A, 3B, 1, 2, 3A, 3B, 8A, 8B, 8C, 8D, 8E, 8F, 8G, 8H, 8I, 8J, 8K, 8L, 8M, 8N, and 8O (FIGS. 8A-8O), in which FIGS. 8A-8O are schematic diagrams receptively illustrating comparisons of parameter values of the first to fifteenth key parameters before and after optimization according to the present disclosure. “Be” denotes “Before” (before optimization), and “Af” denotes “After” (after optimization). As can be seen from the figures, the parameter values distributions before and after optimization are distinctly concentrated within a narrower range, and such result indicates that the MOODFG algorithm of the present disclosure can effectively identify a parameter value region within the parameter space that is most conducive to achieving intended objectives. Thereby, according to the present disclosure, the key parameters x1 can be narrowed to an optimal range through the optimization process, while parameters with nonlinear or multi-objective effects are allowed to retain a defined degree of flexibility. Such balance is crucial for ensuring robust convergence while resolving the inherent complexity of high-dimensional parameter spaces.

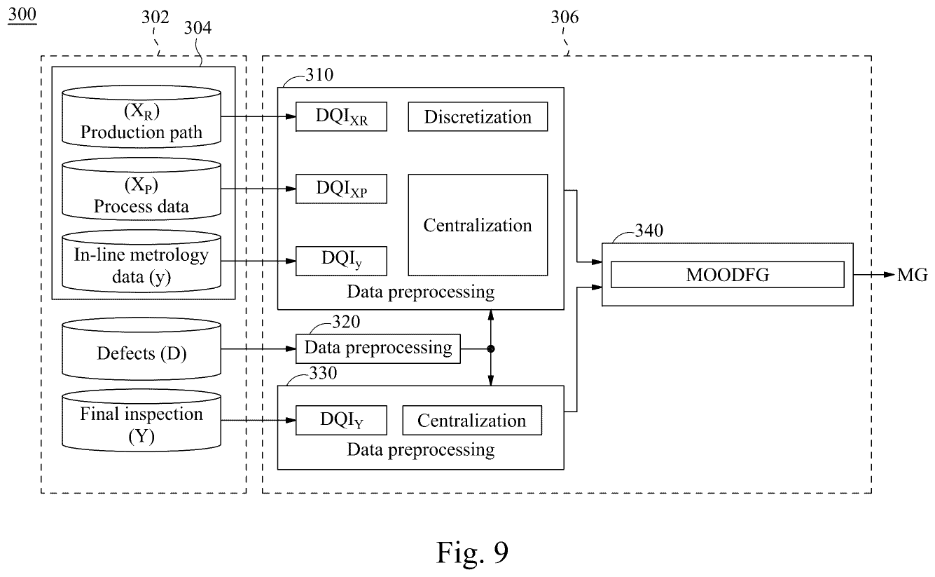

Reference is made to FIGS. 1, 3A, 3B, and 9, in which FIG. 9 is a block schematic diagram illustrating a system 300 for multi-objective parameter optimization with a deep-feature Gaussian process according to a fourth embodiment of the present disclosure. The system 300 for multi-objective parameter optimization with the deep-feature Gaussian process includes a memory 302 and a processor 306, where the memory 302 may include a cloud memory, a random access memory (RAM) that may store information and instructions executable by a processor 306, or other types of dynamic storage devices. The processor 306 may include any type of processor, microprocessor, cloud processor, or field-programmable gate array (FPGA) capable of compiling and executing instructions. The processor 306 may include a single device (e.g., single-core) or a group of devices (e.g., multi-core). The present disclosure is not limited thereto.

The memory 302 stores a production information 304 and a plurality of sets of final inspection values (Y) corresponding to the workpieces. The production information 304 includes a plurality of production paths (XR), and each production path (XR) specifies one of the process devices in the process stations and is configured to process one of the workpieces. The plurality of sets of final inspection values (Y) are obtained by performing at least one yield test on each workpiece after passing through a production line. In detail, the memory 302 stores the production information 304, defects (D), and the final inspection values (Y) corresponding to the workpieces processed in the production line. The production information 304 includes a plurality of production paths (XR), values of process data (X_{P}) for processing workpieces, and multiple sets of inline metrology data (y) of the workpieces, where the process data (X_{P}) includes process parameters and inter-process-device parameters, which can be obtained by a fault detection and classification (FDC) system. Each production path designates one of the process devices in the process stations and is configured to process one workpiece. The production paths can be obtained by a manufacturing execution system (MES). The multiple sets of in-line metrology data (y) are obtained by measuring the workpieces after being processed by corresponding process devices, while the multiple sets of final inspection values (Y) are obtained by performing at least one yield test on each workpiece after passing through the production line. The defects (D) may occur in any process station and are therefore input for analysis. Subsequently, processed defects (D) may be incorporated into the production information 304 or final inspection values (Y) according to the nature of the defects (D). The in-line metrology data (y), the defects (D), and the final inspection values (Y) can be obtained by an engineering data collection (EDC) system. The production line, the process stations, the process devices, the FDC system, the MES, and the EDC system employ a process data quality assessment method similar to that used in the U.S. Patent Application No. 20230153846 A1. Embodiments of the present disclosure refer to the relevant provisions of the U.S. Patent Application No. 20230153846 A1 (incorporated by reference).

The processor 306 is electrically connected to the memory 302. The processor 306 receives the production paths (XR) and the multiple sets of final inspection values (Y), and is configured to implement a method 340 for multi-objective parameter optimization with a deep-feature Gaussian process (e.g., any one of the methods S0 and S2 for multi-objective parameter optimization with the deep-feature Gaussian process shown in FIGS. 3A and 3B). In the processor 306, data preprocessing steps 310, 320, 330 are first performed to verify the quality of all inputs: the production information 304 (X_{R}, X_{P}, y), the defects (D), and the final inspection values (Y). The characteristics of the inputs are described below. X_{R} must be discretized into 1 or 0, indicating whether a workpiece has passed the process station. X_{P} includes data of the process parameters (e.g., voltage, pressure, temperature, etc.) of the process devices and the inter-process-device parameters, which must be centralized. As for the defects (D), different companies have different defect definitions, therefore, discussions with domain experts must be conducted prior to performing data preprocessing and data inspection. The final inspection values (Y) represent yield test results, which need to be centralized.

The data quality evaluation algorithm of X_{R}, denoted as a process data quality index (DQI_{XR}), evaluates the following facts: (1) while a process stage may contain several process devices of the same type, the process stage utilizes only one of the process devices; (2) if a production line should get through multiple process devices (such as three process devices) of the same process device type, then the production line has three process stages at which the three process devices are located respectively; (3) if a process device is used in different production lines, the same device in a different production line would be considered as a different process stage; (4) there are only two possibilities for a workpiece passing through the process device: get through (“1”) or not (“0”); and (5) a workpiece cannot get through any process device that does not belong to that process stage.

Similarly, the data quality evaluation algorithms of X_{P} and y are denoted as DQI_{XP}, and DQIy, respectively. The data quality evaluation algorithm of Y is denoted as DQI_{Y}. Both DQI_{XP} and DQIy adopt the algorithms similar to the process data quality evaluation scheme utilized in U.S. Pat. No. 8,095,484 B2, and DQI_{Y} also applies the algorithm similar to the metrology data quality evaluation scheme used in U.S. Pat. No. 8,095,484 B2. U.S. Pat. No. 8,095,484 B2 is hereby incorporated by reference.

After the data preprocessing steps 310, 320, 330 are completed, the processor 306 performs the method 340 for multi-objective parameter optimization with the deep-feature Gaussian process (e.g., any one of the methods S0 and S2 for multi-objective parameter optimization with the deep-feature Gaussian process shown in FIGS. 3A and 3B). The method 340 for multi-objective parameter optimization with the deep-feature Gaussian process includes a MOODFG algorithm, which can generate outputs MG (e.g., the optimal parameter combination x2 and the objective function f(x2) thereof in FIG. 1). Based on experimental validation using real-world Epi SiC manufacturing data, the MOODFG framework of the present disclosure achieves significant improvements in yield, parameter stability, and process adaptability, highlighting the framework's transformative potential for semiconductor manufacturing.

It is understood that the methods S0 and S2 for multi-objective parameter optimization with the deep-feature Gaussian process according to the present disclosure are the implementation steps described above. A computer program product of the present disclosure is configured to complete the methods S0 and S2 for multi-objective parameter optimization with the deep-feature Gaussian process. The sequence of the implementation steps described in the above embodiments may be adjusted, combined, or omitted based on practical requirements. The above embodiments may be implemented via the computer program product which can include a machine-readable medium storing a plurality of instructions that can program a computer to perform the steps in the above embodiments. The machine-readable medium can be, but is not limited to, a floppy diskette, an optical disk, a compact disk-read-only memory (CD-ROM), a magneto-optical disk, a read-only memory (ROM), a random access memory (RAM), an erasable programmable read-only memory (EPROM), an electrically erasable programmable read-only memory (EEPROM), a magnetic or optical card, a flash memory, or another type of media/machine-readable medium suitable for storing electronic instructions. Moreover, the embodiments of the present disclosure also can be downloaded as a computer program product, which may be transferred from a remote computer to a requesting computer by using data signals via a communication link (such as a network connection or the like).

It can also be noted that the present disclosure may also be described within a context of a manufacturing system. While the present disclosure can be implemented in a semiconductor manufacture, it is not limited thereto and can also be applied to other manufacturing industries. The manufacturing system is configured to manufacture workpieces or products which include, but are not limited to, microprocessors, memory devices, digital signal processors, application-specific integrated circuits (ASICs), or other similar devices. The present disclosure may also be applied to workpieces or products other than semiconductor devices, such as vehicle wheel rims or screws. The manufacturing system includes one or more processing tools which can be configured to form one or more products or portions thereof on or within a workpiece (e.g., a wafer, a glass substrate). Those of ordinary skill in the art should understand that the processing tools may be of any number and type, and include lithography tools, deposition tools, etching tools, polishing tools, annealing tools, machining tools, and similar tools. In the embodiments, the manufacturing system further includes a scatterometer, an ellipsometer, a scanning electron microscope (SEM), and similar instruments.

As can be seen from the above implementations, the present disclosure has the following advantages: 1. Objective-oriented optimal parameter recommendation: the present disclosure employs an objective-oriented optimization strategy that directly targets user-defined multi-objective metrology data or yield requirements for optimization. The MOODFG algorithm can effectively identify optimal parameter combinations by integrating deep-feature extraction with Gaussian process modeling, so that the process can achieve optimal performance under specific objective conditions. 2. Dynamic feature learning and model updating: the present disclosure introduces an incremental learning framework that allows dynamic updating of feature representations and Gaussian process models when new data is added. This capability ensures that the system operates robustly when process conditions change, and continuously provides high-precision parameter recommendations. 3. Cross-parameter nonlinear interaction modeling: through deep-feature extraction, high-dimensional parameters can be mapped to a low-dimensional latent space, which captures nonlinear relationships between the parameters. After the Gaussian process models are combined, the method can effectively identify how the parameters interactively influence objective metrology data or yields. 4. Automatic generation of dynamic recommendations: a surrogate model and iterative learning are employed to automatically generate dynamic adjustment recommendations based on current process data. For example, for specific objectives such as thickness uniformity and doping concentration, the system can recommend gas flow rates or temperature settings in real time, and provide trade-off solutions to balance multiple objective requirements. 5. By utilizing the synergy between the MES layer, the EPCS/RMS layer, the equipment layer, the APC layer, and the SPC layer and integrating them with the MOODFG layer, the visibility, predictive analytics, and parameter optimization of the flow can be significantly enhanced. The workflow not only maximizes the efficiency and output of the process, but also lays a solid foundation for the development of future adaptive and autonomous manufacturing systems, thereby promoting the continuous development of the semiconductor manufacturing landscape.

Although the present disclosure has been described with embodiments above, the embodiments are not intended to limit the present disclosure. Any person skilled in the art may make various modifications and alterations without departing from the spirit and scope of the present disclosure. Therefore, the scope of protection of the present disclosure shall be defined by the appended claims.

What is claimed is:

1. A system for multi-objective parameter optimization with a deep-feature Gaussian process, comprising:
a memory storing a plurality of process data, a plurality of metrology/testing data, and a specified multi-objective requirement, wherein the process data are used or generated when a production machine processes a plurality of workpieces, the process data are one-to-one corresponding to the workpieces, each of the process data comprises a plurality of process parameters, the metrology/testing data comprise a plurality of metrology data of the workpieces, and the specified multi-objective requirement comprises a plurality of specified objective values corresponding to a plurality of objectives; and
a processor electrically connected to the memory, the processor receiving the process data, the metrology/testing data, and the specified multi-objective requirement, and configured to perform operations comprising:
performing a data processing and feature selection operation, the data processing and feature selection operation comprising analyzing the process data and the metrology/testing data by using a classification algorithm to select a plurality of key parameters relevant to the objectives;
performing a deep-feature extraction and Gaussian process modeling operation, the deep-feature extraction and Gaussian process modeling operation comprising:
performing a deep-feature extraction operation, the deep-feature extraction operation comprising employing a deep learning model to perform deep-feature extraction on the key parameters, map the key parameters to a latent space, and generate a plurality of transformed feature vectors, wherein the key parameters have a higher dimensionality than the latent space; and
performing a Gaussian process modeling operation, the Gaussian process modeling operation comprising establishing a Gaussian process model for each of the objectives and inputting the transformed feature vectors into the Gaussian process model to generate an objective value; and
performing an optimization and parameter recommendation operation, the optimization and parameter recommendation operation comprising performing a multi-objective optimization based on the deep learning model, the Gaussian process model, and an iterative approach to search for an optimal parameter combination in which the objective values respectively corresponding to the objectives satisfy the specified multi-objective requirement.

2. The system for multi-objective parameter optimization with the deep-feature Gaussian process according to claim 1, wherein the multi-objective optimization comprises simultaneously optimizing the objectives corresponding to a semiconductor manufacture, the semiconductor manufacture comprises an epitaxial silicon carbide (Epi SiC) process, and the objectives comprise a thickness uniformity and a doping concentration.

3. The system for multi-objective parameter optimization with the deep-feature Gaussian process according to claim 1, wherein the classification algorithm is analyzed as an extreme Gradient Boosting (XGboost) algorithm, the deep learning model is a two-layer neural network, and the two-layer neural network comprises two rectified linear unit (ReLU) functions.

4. The system for multi-objective parameter optimization with the deep-feature Gaussian process according to claim 1, wherein the data processing and feature selection operation, the deep-feature extraction and Gaussian process modeling operation, and the optimization and parameter recommendation operation are sequentially performed, and the deep-feature extraction operation is performed prior to the Gaussian process modeling operation.

5. The system for multi-objective parameter optimization with the deep-feature Gaussian process according to claim 1, wherein,
in the data processing and feature selection operation, a number of the key parameters is less than a number of the process parameters of the process data;
in the deep-feature extraction operation, a dimensionality of the key parameters is higher than a dimensionality of the transformed feature vectors; and
the iterative approach comprises an iteration counter, and the iteration counter is greater than or equal to 10 and less than or equal to 60.

6. The system for multi-objective parameter optimization with the deep-feature Gaussian process according to claim 1, wherein the Gaussian process model is configured to surrogate an objective function corresponding to each of the objectives, the transformed feature vectors are input into the Gaussian process model to generate the objective value and an uncertainty estimation, and the optimization and parameter recommendation operation further comprises:
searching for a current optimal parameter combination based on a plurality of the uncertainty estimations corresponding to the Gaussian process models of the objectives, to minimize deviations between the objective values generated by the Gaussian process models and the specified multi-objective requirement, wherein the current optimal parameter combination corresponds to the process parameters at a current time; and
updating the deep learning model and the Gaussian process models using the iterative approach until the objective values generated by the updated Gaussian process models converge to the specified objective values of the specified multi-objective requirement;
wherein the multi-objective optimization corresponds to the objectives, and the optimal parameter combination corresponds to the process parameters satisfying the specified multi-objective requirement.

7. A method for multi-objective parameter optimization with a deep-feature Gaussian process, comprising:
obtaining, by a processor, a plurality of process data, a plurality of metrology/testing data, and a specified multi-objective requirement, wherein the process data are used or generated when a production machine processes a plurality of workpieces, the process data are one-to-one corresponding to the workpieces, each of the process data comprises a plurality of process parameters, the metrology/testing data comprise a plurality of metrology data of the workpieces, and the specified multi-objective requirement comprises a plurality of specified objective values corresponding to a plurality of objectives;
performing, by the processor, a data processing and feature selection operation, the data processing and feature selection operation comprising analyzing the process data and the metrology/testing data by using a classification algorithm to select a plurality of key parameters relevant to the objectives;
performing, by the processor, a deep-feature extraction and Gaussian process modeling operation, the deep-feature extraction and Gaussian process modeling operation comprising:
performing a deep-feature extraction operation, the deep-feature extraction operation comprising employing a deep learning model to perform deep-feature extraction on the key parameters, map the key parameters to a latent space, and generate a plurality of transformed feature vectors, wherein the key parameters have a higher dimensionality than the latent space; and
performing a Gaussian process modeling operation, the Gaussian process modeling operation comprising establishing a Gaussian process model for each of the objectives and inputting the transformed feature vectors into the Gaussian process model to generate an objective value; and
performing, by the processor, an optimization and parameter recommendation operation, the optimization and parameter recommendation operation comprising performing a multi-objective optimization based on the deep learning model, the Gaussian process model, and an iterative approach to search for an optimal parameter combination in which the objective values respectively corresponding to the objectives satisfy the specified multi-objective requirement.

8. The method for multi-objective parameter optimization with the deep-feature Gaussian process according to claim 7, wherein the multi-objective optimization comprises simultaneously optimizing the objectives corresponding to a semiconductor manufacture, the semiconductor manufacture comprises an epitaxial silicon carbide (Epi SiC) process, and the objectives comprise a thickness uniformity and a doping concentration.

9. The method for multi-objective parameter optimization with the deep-feature Gaussian process according to claim 7, wherein the classification algorithm is analyzed as an eXtreme Gradient Boosting (XGboost) algorithm, the deep learning model is a two-layer neural network, and the two-layer neural network comprises two rectified linear unit (ReLU) functions.

10. The method for multi-objective parameter optimization with the deep-feature Gaussian process according to claim 7, wherein the data processing and feature selection operation, the deep-feature extraction and Gaussian process modeling operation, and the optimization and parameter recommendation operation are sequentially performed, and the deep-feature extraction operation is performed prior to the Gaussian process modeling operation.

11. The method for multi-objective parameter optimization with the deep-feature Gaussian process according to claim 7, wherein,
in the data processing and feature selection operation, a number of the key parameters is less than a number of the process parameters of the process data;
in the deep-feature extraction operation, a dimensionality of the key parameters is higher than a dimensionality of the transformed feature vectors; and
the iterative approach comprises an iteration counter, and the iteration counter is greater than or equal to 10 and less than or equal to 60.

12. The method for multi-objective parameter optimization with the deep-feature Gaussian process according to claim 7, wherein the Gaussian process model is configured to surrogate an objective function corresponding to each of the objectives, the transformed feature vectors are input into the Gaussian process model to generate the objective value and an uncertainty estimation, and the optimization and parameter recommendation operation further comprises:
searching for a current optimal parameter combination based on a plurality of the uncertainty estimations corresponding to the Gaussian process models of the objectives, to minimize deviations between the objective values generated by the Gaussian process models and the specified multi-objective requirement, wherein the current optimal parameter combination corresponds to the process parameters at a current time; and
updating the deep learning model and the Gaussian process models using the iterative approach until the objective values generated by the updated Gaussian process models converge to the specified objective values of the specified multi-objective requirement;
wherein the multi-objective optimization corresponds to the objectives, and the optimal parameter combination corresponds to the process parameters satisfying the specified multi-objective requirement.

13. A non-transitory computer readable storage medium having a plurality of instructions that, when executed on a processor, cause the processor to perform a method for multi-objective parameter optimization with a deep-feature Gaussian process, the method for multi-objective parameter optimization with the deep-feature Gaussian process comprising:
obtaining, by a processor, a plurality of process data, a plurality of metrology/testing data, and a specified multi-objective requirement, wherein the process data are used or generated when a production machine processes a plurality of workpieces, the process data are one-to-one corresponding to the workpieces, each of the process data comprises a plurality of process parameters, the metrology/testing data comprise a plurality of metrology data of the workpieces, and the specified multi-objective requirement comprises a plurality of specified objective values corresponding to a plurality of objectives;
performing, by the processor, a data processing and feature selection operation, the data processing and feature selection operation comprising analyzing the process data and the metrology/testing data by using a classification algorithm to select a plurality of key parameters relevant to the objectives;
performing, by the processor, a deep-feature extraction and Gaussian process modeling operation, the deep-feature extraction and Gaussian process modeling operation comprising:
performing a deep-feature extraction operation, the deep-feature extraction operation comprising employing a deep learning model to perform deep-feature extraction on the key parameters, map the key parameters to a latent space, and generate a plurality of transformed feature vectors, wherein the key parameters have a higher dimensionality than the latent space; and
performing a Gaussian process modeling operation, the Gaussian process modeling operation comprising establishing a Gaussian process model for each of the objectives and inputting the transformed feature vectors into the Gaussian process model to generate an objective value; and
performing, by the processor, an optimization and parameter recommendation operation, the optimization and parameter recommendation operation comprising performing a multi-objective optimization based on the deep learning model, the Gaussian process model, and an iterative approach to search for an optimal parameter combination in which the objective values respectively corresponding to the objectives satisfy the specified multi-objective requirement.

14. The non-transitory computer readable storage medium according to claim 13, wherein the multi-objective optimization comprises simultaneously optimizing the objectives corresponding to a semiconductor manufacture, the semiconductor manufacture comprises an epitaxial silicon carbide (Epi SiC) process, and the objectives comprise a thickness uniformity and a doping concentration.

15. The non-transitory computer readable storage medium according to claim 13, wherein the classification algorithm is analyzed as an extreme Gradient Boosting (XGboost) algorithm, the deep learning model is a two-layer neural network, and the two-layer neural network comprises two rectified linear unit (ReLU) functions.

16. The non-transitory computer readable storage medium according to claim 13, wherein the data processing and feature selection operation, the deep-feature extraction and Gaussian process modeling operation, and the optimization and parameter recommendation operation are sequentially performed, and the deep-feature extraction operation is performed prior to the Gaussian process modeling operation.

17. The non-transitory computer readable storage medium according to claim 13, wherein,
in the data processing and feature selection operation, a number of the key parameters is less than a number of the process parameters of the process data;
in the deep-feature extraction operation, a dimensionality of the key parameters is higher than a dimensionality of the transformed feature vectors; and
the iterative approach comprises an iteration counter, and the iteration counter is greater than or equal to 10 and less than or equal to 60.

18. The non-transitory computer readable storage medium according to claim 13, wherein the Gaussian process model is configured to surrogate an objective function corresponding to each of the objectives, the transformed feature vectors are input into the Gaussian process model to generate the objective value and an uncertainty estimation, and the optimization and parameter recommendation operation further comprises:
searching for a current optimal parameter combination based on a plurality of the uncertainty estimations corresponding to the Gaussian process models of the objectives, to minimize deviations between the objective values generated by the Gaussian process models and the specified multi-objective requirement, wherein the current optimal parameter combination corresponds to the process parameters at a current time; and
updating the deep learning model and the Gaussian process models using the iterative approach until the objective values generated by the updated Gaussian process models converge to the specified objective values of the specified multi-objective requirement;
wherein the multi-objective optimization corresponds to the objectives, and the optimal parameter combination corresponds to the process parameters satisfying the specified multi-objective requirement.
